(19) United States
(12) Patent Application Publication
(10) Pub. No.: US 2011/0040618 A1
(43) Pub. Date: Feb. 17, 2011

(54) STATIC AND DYNAMIC WORKING CONTEXT WITHIN CRM SYSTEM

(75) Inventor: Timo Wagenblatt, Erfweiler (DE)

Correspondence Address: SAP AG c/o FOLEY & LARDNER, LLP, 777 EAST WISCONSIN AVENUE, SUITE 3300, MILWAUKEE, WI, 53202-5367, US

(73) Assignee: SAP Aktiengesellschaft

(21) Appl. No.: 12/539,513

(22) Filed: Aug. 11, 2009

(51) Int. Cl. G06Q 10/00; G06Q 30/00

(52) U.S. Cl. 705/14.46; 705/14.61

(57) ABSTRACT

A system and method for managing sales using an automated process. The system and method may utilize machine-readable media including program code stored therein executable by one or more processors to perform the automated process. The automated process including providing a working context related to a dynamic characteristic and providing data assigned to the dynamic characteristic.

### BACKGROUND

The present disclosure relates generally to the field of sales, service, and marketing management. More specifically, the disclosure relates to streamlining the sales, service, and marketing management and/or the sales, service, and marketing data management process by providing working context that is utilized to match the working context attributes with information (e.g., list views, calendar views, invoices, orders, assortment plans, markdown profiles, product pricing, product quantity, product life cycle cost, and/or any other data) from the sales, service, and marketing data management process to enable an enhanced customer centered, sales, service, and/or marketing focused information view.

### SUMMARY

One embodiment of the disclosure relates to a system and method for managing sales using an automated process. The automated process includes providing a working context and data assigned to the working context. The automated process further includes generating a trade promotion based on the working context and automatically populate the trade promotion with data based on the working context.

Another embodiment of the disclosure relates to a system and method for managing sales using an automated process. The automated process includes providing a working context related to a dynamic characteristic and providing data assigned to the dynamic characteristic.

Another embodiment of the disclosure relates to a system and method for managing sales using an automated process. The automated process includes providing a first working context related to a static characteristic and providing a first data assigned to the first working context. The automated process further includes providing a second working context related to a dynamic characteristic and providing a second data assigned to the second working context.

### BRIEF DESCRIPTION OF THE DRAWINGS

FIG. 1 is a block diagram, according to one exemplary embodiment;

FIG. 2 is a communication block diagram, according to an exemplary embodiment;

FIG. 3A is a screen shot of the working context template, according to one exemplary embodiment;

FIG. 3B is another screen shot of the working context template, according to one exemplary embodiment;

FIG. 4 is a flowchart relating to the working context selection process, according to one exemplary embodiment;

FIG. 5 is an illustration of various sales management locations, according to exemplary embodiments;

FIGS. 6A-6C are illustrations of the calendar functionality being utilized as a dynamic characteristic, according to an exemplary embodiment;

FIGS. 7A-7C are illustrations of incoming data being utilized as a dynamic characteristic, according to an exemplary embodiment;

FIG. 8 shows illustrations of sales locations being utilized as dynamic characteristics, according to exemplary embodiments;

FIG. 9 is a flowchart for the working context implementation, according to an exemplary embodiment; and

FIG. 10 is another flowchart for the working context implementation, according to an exemplary embodiment.

### DETAILED DESCRIPTION OF THE EXEMPLARY EMBODIMENTS

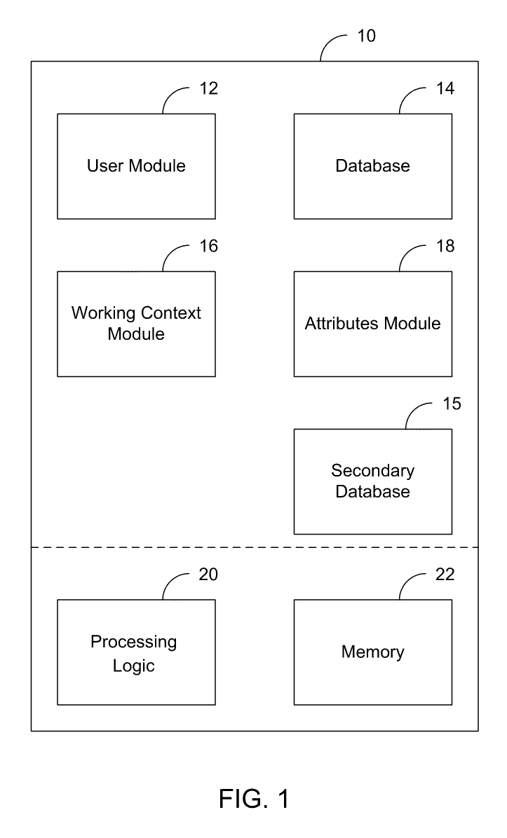

Referring to FIG. 1, a block diagram of a sales management system 10 is shown, according to an exemplary embodiment. Sales management system 10 may include a user module 12, a database 14, a working context module 16, an attributes module 18, a processing logic 20, and a memory 22. In an exemplary embodiment, user module 12 may include various user profiles. For example, a Key Account Manager for five clients may have a user profile that is matched to these five clients. In another example, a Key Account Manager for certain products (e.g., cookies) may have a user profile that is matched to all of these certain products (e.g., all of the cookie products) available in database 14. Further, a call center representative may have a user profile that allows the call center representative to have access to all of the data in database 14.

In an exemplary embodiment, processing logic 20 may utilize working context module 16 to determine which attributes should be accessed from database 14. For example, working context module 16 may determine that the working context is chocolate cookies for all of client's stores during the last thirty days. Processing logic 20 may utilize these working context attributes and request that attributes module 18 access database 14 to present a filtered view of the database that includes only the data associated with these attributes. The filtered view may be stored in memory 22 or in a secondary database 15. In exemplary embodiments, when processing logic 20 utilizes these working attributes to access database 14, the result may be filtered data, the creation of a temporary database, or the creation of secondary database 15. Processing logic 20 and memory 22 may be integrated into user module 12, working context module 16, attributes module 18, or any combination thereof. In an exemplary embodiment, processing logic 20 and memory 22 may be a separate system. In an exemplary embodiment, working context may be based on the combination of static working context and the dynamic working context.

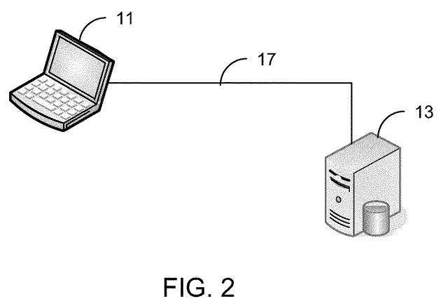

In FIG. 2, a communication block diagram is shown, according to an exemplary embodiment. In an exemplary embodiment, a computing device 11 communicates with a server 13 via a communication link 17. Communication link 17 may be the internet. In an exemplary embodiment, communicating over communication link 17 allows computing device 11 to have continual access to database 14. In another exemplary embodiment, computing device 11 communicates with server 13 via the intranet. In an exemplary embodiment, server 13 downloads onto computing device 11 secondary databases 15 which may be utilized in isolation of server 13. In an exemplary embodiment, portions of user module 12, working context module 16, and/or attributes module 18 may be located and/or stored on computing device 11 and server 13. In another exemplary embodiment, user module 12, working context module 16, and/or attributes module 18 may be located and/or stored on computing device 11. In another exemplary embodiment, user module 12, working context module 16, and/or attributes module 18 may be located and/or stored on and server 13.

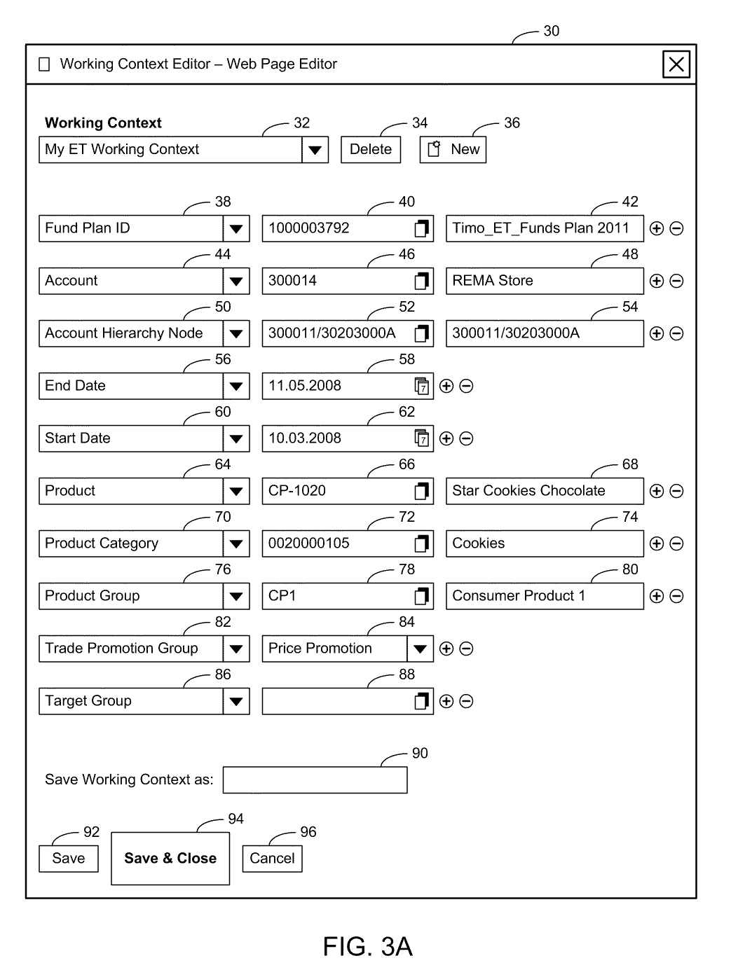

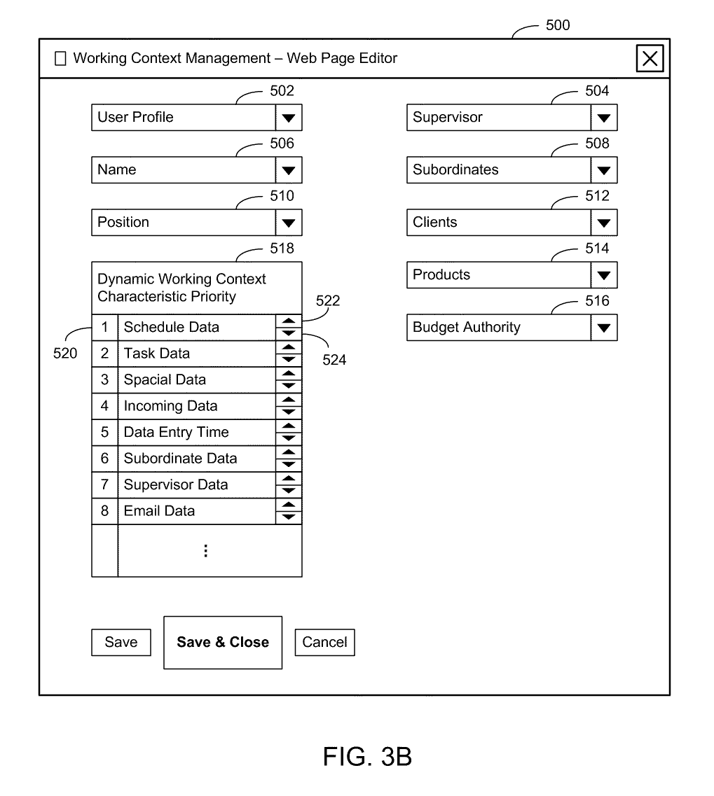

In FIG. 3A, a screen shot of a working context template 30 is shown, according to one exemplary embodiment. A working context pull-down window 32 may identify one working context template 30, a few working context templates 30, or many working context templates 30. When a working context template 30 is selected, the working context may be loaded from database 14 and displayed. In exemplary embodiments, working context data may be displayed, transferred, populated into templates (e.g., trade promotion templates, trade claim templates, trade funds template, etc.), or utilized in the system by various applications. In an exemplary embodiment, a saved working context template 30 may be deleted by utilizing a delete button 34. In another exemplary embodiment, once the working context template 30 is deleted, the next saved working context in the list may become active. A new button 36 may create a new working context and default all attributes, according to a business role.

In an exemplary embodiment, clicking on the + key may add a new empty line. In another exemplary embodiment, clicking on the − key may delete the current line. Clicking on a save key 92 may save the displayed context values under a given context name for the current business role. In another exemplary embodiment, the context values may become active once the context values are saved. Clicking on a save and close key 94 may save the displayed context values under a given context name for the current business role and closes the working context popup. Clicking a cancel key 96 closes the module without saving any changes.

Working context template 30 may include a fund plan identification field 38, an account field 44, an account hierarchy node field 50, an end date field 56, a start date field 60, a product field 64, a product category field 70, a product group field 76, a trade promotion group field 82, a price promotion group field 84, a target group field 86, and a miscellaneous field 88, according to an exemplary embodiment. Fund plan identification field 38 may be related to a fund number field 40 and a fund description field 42. Account field 44 may be related to an account number field 46 and an account description field 48. Account hierarchy node field 50 may be related to an account hierarchy number field 52 and an account hierarchy node description field 54. End date field 56 may be related to an end date number field 58. Start date field 60 may be related to a start date number field 62. Product field 64 may be related to a product number field 66 and a product description field 68. Product category field 70 may be related to a product category number field 72 and a product category description field 74. Product group field 76 may be related to a product group number field 78 and a product group description field 80.

In an exemplary embodiment, an attribute may be in a default configuration and may be utilized within the database as a working context attribute (e.g., priority, status, etc.). In addition, multiple values may be utilized for a working context. For example, a number of products (e.g., five, ten, twenty, etc.) may be a working context for an individual (e.g., Marketing Manager, Sales Representative, Service Representative, etc.). In an exemplary embodiment, the products may be prioritized (e.g., from 1 to n).

In an exemplary embodiment, trade promotion group 82 may be a price promotion, an advertising promotion, a coupon promotion, a product placement promotion, a volume discount promotion (e.g., buy two get one free), a complimentary product promotion (e.g., package hot dogs and buns together), a first mover promotion (e.g., the product will be released in one month but if you buy it now you get it in three weeks), and/or any other type of sales promotion.

In FIG. 3B, another screen shot of a working context template 500 is shown, according to one exemplary embodiment. In an exemplary embodiment, working context template 500 includes a user profile field 502, a supervisor field 504, a name field 506, a subordinates field 508, a position field 510, a clients field 512, a products field 514, a budget authority field 516, and a dynamic working context characteristics field 518. User profile field 502 may be a pull-down field which includes one, a few, many, or a plurality of user profiles. In exemplary embodiments, all fields may be pull-down fields. A user profile may be based on position data (e.g., Key Account Manager), supervisor data (e.g., Joe Black is the Key Account Manager's boss), subordinate data (e.g., Jill Jones reports to Key Account Manager), client data (e.g., Walmart, Walgreens, Kmart, and Sears are clients of Key Account Manager), product data (e.g., Star Cookies, Star Chocolates, Star Bread, Star Butter, Star Ice Cream, and Star Gum are products assigned to Key Account Manager), budget authority data (e.g., Key Account Manager may approve budget requests up to $100,000), and any other type of user specific data. Supervisor field 504 may include data related to the user's supervisor. Name field 506 may include data related to the user's name. Subordinate field 508 may include data related to subordinates for the user profile. Position field 510 may include data related to the position of the user in the user profile. Clients field 512 may include data related to the clients assigned to the user in the user profile. Products field 514 may include data related to the products assigned to the user in the user profile. Budget authority field 516 may include data (e.g., may approve up to $5,000, may approve up to $50,000, may approve up to $1,000,000, etc.) related to the approval authority of the user in the user profile.

In an exemplary embodiment, dynamic working context characteristic field 518 may include various dynamic characteristics that may be utilized to generate a working context. In exemplary embodiments, dynamic characteristics may be schedule data, task data, spacial data, incoming data (e.g., non-manually entered data), data entry time, subordinate data, supervisory data, email data, or any other type of dynamic data. A priority field 520 may be utilized to prioritize which dynamic characteristic will be utilized when more than one dynamic characteristic may be utilized by the system. For example, schedule data may have a priority one and spacial data may have a priority three. If schedule data indicates that a working context1 should be utilized and spacial data indicates that a working context2 should be utilized, then the system will utilize a working context1 based on the schedule data have a higher priority than the spacial data. In an exemplary embodiment, a move-up key 522 may be utilized to increase the priority of a dynamic characteristic. In another exemplary embodiment, a move-down key 524 may be utilized to decrease the priority of a dynamic characteristic. Further, the priority data may be entered and/or modified by entering the data in priority field 520.

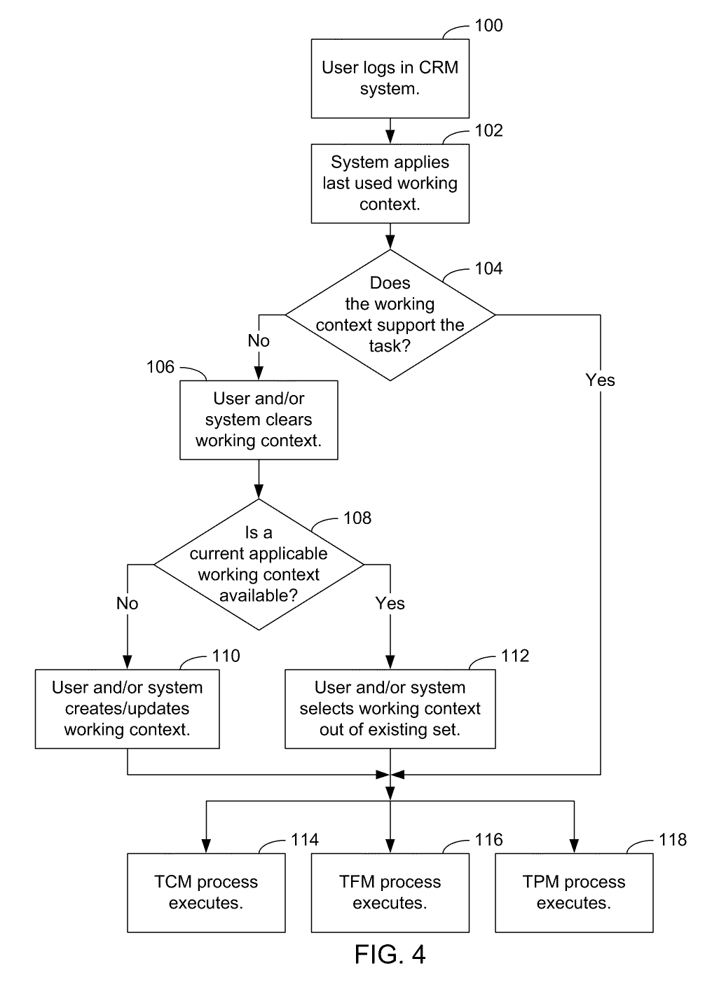

In FIG. 4, a process flowchart relating to the working context selection process is shown, according to one exemplary embodiment. In an exemplary embodiment, a person logs into the system (step 100). The system may apply the working context last used by the system or user (step 102). A determination is made as to whether the working context supports the task (step 104). If the working context supports the task, then the system moves to the Trade Claims Management process, the Trade Funds Management process, and/or the Trade Promotion Management process (steps 114, 116, and 118). If the working context does not support the task, then the user and/or the system clears the working context (step 106). The system determines whether a current applicable working context is available (step 108). If a current applicable working context is available, then the user and/or the system selects a working context (step 112). The system would then move on to the Trade Claims Management process, the Trade Funds Management process, and/or the Trade Promotion Management process (steps 114, 116, and 118). If a current applicable working context is unavailable, then the user and/or the system creates/updates a working context (step 110). The system would then move on to the Trade Claims Management process, the Trade Funds Management process, and/or the Trade Promotion Management process (steps 114, 116, and 118).

The Trade Promotion Management application may allow account and trade managers to improve control and visibility of the entire trade promotion process. In an exemplary embodiment, the integrated end-to-end solution may enable managers to accurately plan, increase brand presence, and maximize profitability with trade activities. Trade Funds Management may manage the use of trade funds and optimize trade promotion activities. Trade Funds Management may close the loop on funding and settlement processes by integrating trade funds to trade claims. In an exemplary embodiment, Trade Funds Management may manage trade expenses to planned fund amounts. Trade Funds Management may centrally manage and monitor all trade funds, budget tracking, allocation setting, and utilization. Account planning may develop account volume and execution plans that are aligned with headquarters' plans and objectives. In an exemplary embodiment, account planning may be utilized to gain insights into all relevant marketing and promotional activities through the marketing calendar. Account planning may allow for developing the best account plans via promotion simulation analysis. Further, account planning may automate the approval process from the headquarters out to the field and to the customer and manage promotion planning to indirect customers. Trade Promotion Management may be utilized to develop and execute effective trade promotions to drive sales volumes and brand awareness. In an exemplary embodiment, Trade Promotion Management may increase planning efficiencies with promotional templates, promotional guidelines, and agreements. Further, Trade Promotion Management may help to avoid stock outs by integrating the trade promotion planning process with the demand planning process. Trade Promotion Management may facilitate promotion sell-in efforts by utilizing historical data and trends. In an exemplary embodiment, Trade Promotion Management may capture all orders and collateral requests, and provide feedback information into the demand planning process. Trade Promotion Management may also manage field activities with activity management tools to plan customer visits and to perform surveys. Trade Promotion Management may improve in-store merchandising execution via follow-up store visits and analyzing in-store competition. Trade Claims Management may manage disputes according to agreed contracts. In an exemplary embodiment, Trade Claims Management may manage all claims with visibility into funds, promotion planning, and validation data. Trade Claims Management may manage all deductions and payments, including charge-backs, write-offs, and period-end rebates. Trade Claims Management may validate retail promotion performance to ensure only valid claims are paid. Further, Trade Claims Management may link claims to associated funds and promotions at payment for accurate accounting. Trade Promotion Management may provide trade promotion analytics which allows the user to make mid-course adjustments to trade plans based on on-going trade execution results. Further, the trade promotion analytics allows the user to gain insight into trade promotional effectiveness at multiple levels including brand, product, category, account, and segments. Utilizing these tools, the user may understand total trade promotional spending and resulting volume, profitability, and ROI, which leads to increased planning and forecasting accuracy based on historical performance data and access to financial and demand planning data.

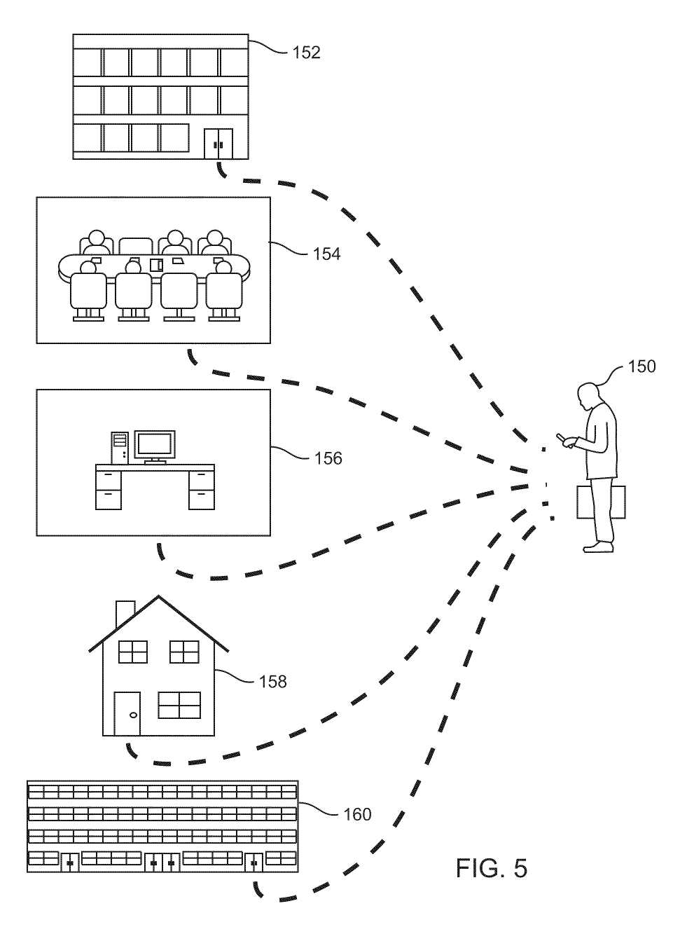

In FIG. 5, illustrations of various sales management locations are shown, according to exemplary embodiments. A salesperson 150 may travel to numerous locations during the sales cycle. In exemplary embodiments, salesperson 150 may travel to a client site 152, a conference room 154, a sales office 156, a home 158, a call center 160, a trade show, a warehouse, etc. In an exemplary embodiment, working context module 16 may apply a working context to a user based on a person digital assistant functionality (e.g., calendar, task, global positioning signal, contacts list, etc.), and/or recent client searches.

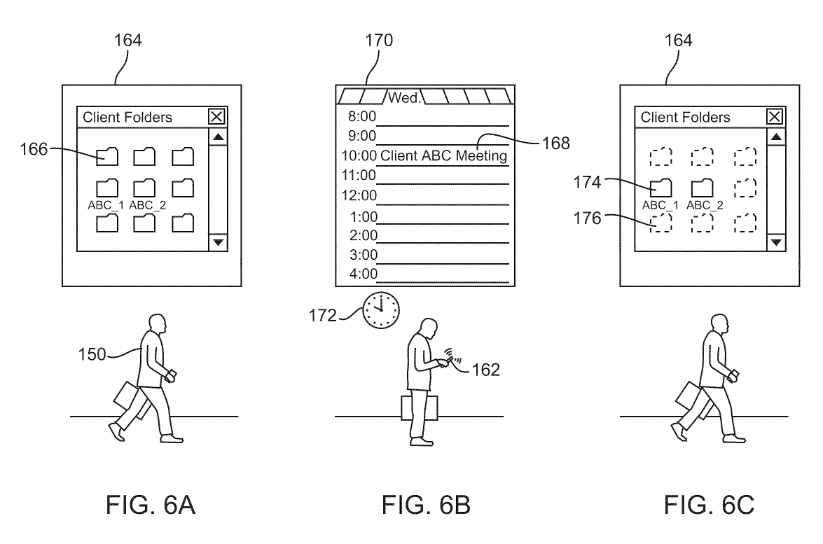

In FIGS. 6A-6C, an illustration of a personal digital assistant functionality (e.g., calendar) being utilized as a dynamic characteristic is shown, according to an exemplary embodiment. In FIG. 6A, salesperson 150 is traveling to a client meeting and has access to all of the salesperson's client folders 166 based on the salesperson's static working context which is shown in a window 164, according to an exemplary embodiment. For example, salesperson 150 may have five clients and would have access to specific data files related to these five clients.

In FIG. 6B, salesperson 150 may have a personal digital assistant 162. Salesperson 150 may have a calendar entry 168, which indicates that salesperson 150 has a ten o'clock appointment with Client ABC. In this exemplary embodiment, a clock 172 indicates that the time is ten o'clock. Based on the dynamic working context of salesperson 150 having calendar entry 168 which indicates that salesperson 150 is meeting with Client ABC, salesperson's working context has changed and now salesperson 150 may only be able to access Client ABC files 174 (see FIG. 6C). In an exemplary embodiment, Non-Client ABC files 176 may not be displayed to salesperson 150. In exemplary embodiments, Non-Client ABC files 176 may be accessed once the meeting with Client ABC is finished which may be based on the calendar functionality, an input from salesperson 150, or another determination that salesperson 150 has left Client ABC (e.g., geographic location). For example, salesperson's calendar may indicate that the meeting with Client ABC starts at ten o'clock and ends at eleven o'clock. Based on the meeting starting at ten o'clock and ending at eleven o'clock, the working context for salesperson 150 may be based on Client ABC from ten o'clock to eleven o'clock. In another example, salesperson's personal digital assistant 162 may have a task function which indicates that salesperson 150 will be working on Client ABC from ten o'clock to eleven o'clock. Based on the task starting at ten o'clock and ending at eleven o'clock, the working context for salesperson 150 may be Client ABC from ten o'clock to eleven o'clock.

In an exemplary embodiment, salesperson 150 may reapply salesperson static working context by resetting the dynamic working context. For example, salesperson 150 may be able to press a clear button on personal digital assistant 162 which removes the dynamic characteristic (e.g., calendar, task, etc.) which was the basis for the dynamic working context. In another embodiment, salesperson's physical location may be the dynamic characteristic which is utilized to determine the working context. For example, salesperson's calendar may indicate that the meeting with Client ABC start at ten o'clock and ends at eleven o'clock. However, based on positioning data obtained from a mobile device (e.g., cell phone, personal digital assistant 162, etc.) salesperson's 150 position is obtained. When salesperson's 150 position no longer corresponds to the location of Client ABC, the dynamic working context may be reset to allow salesperson 150 to obtain all of salesperson's files (e.g., Client ABC files 174 and Non-Client ABC files 176). In exemplary embodiments, the time data and position data may have buffer zones. For example, salesperson's calendar may indicate that the meeting with Client ABC starts at ten o'clock and ends at eleven o'clock. In this example, the system may wait until eleven fifteen before removing the dynamic working context. In another example, the system may remove the dynamic working context early (e.g., ten forty-five) based on salesperson's preferences. In another example, the system may waited until salesperson 150 is a certain distance away (e.g., one mile) before removing the dynamic working context.

In an exemplary embodiment, a Key Account Manager may be assigned to a client. The client may have numerous locations throughout the world. In an exemplary embodiment, the Key Account Manager may want to create a trade program for the client's Atlanta stores for the next fiscal year and for a specific product line (e.g., Star Cookies). In this exemplary embodiment, the Star Cookies may be a node in the product hierarchy. The process may start with an analysis of last years results. For example, the attributes for the working context may be set to client's Atlanta stores (for the customer field), Star Cookies (for the product field), and last fiscal year (for the year field). The Key Account Manager may then request business intelligence reports. In an exemplary embodiment, the business intelligence reports may include volume, revenue, compliance, and effectiveness data related to the client's Atlanta stores, Star Cookies, and the last fiscal year. The Key Account Manager may not need to set a filter for this data because the working context enables delivery of the correct reports for this analysis. The Key Account Manager obtains headquarter planning data for the next fiscal year. For example, forecast data related to the client's Atlanta stores, Star Cookies, and the next fiscal year are received by the system. In an exemplary embodiment, the Key Account Manager navigates the business intelligence reports and forecasts yearly volumes and total revenue. Based on the working context, the Key Account Manager may only be shown relevant data relating to the client's Atlanta stores, the Star Cookies product, and the next fiscal year. For example, the system may only show headquarter goals for the client's Atlanta stores with regard to the Star Cookies product during the next fiscal year. In an exemplary embodiment, the Key Account Manager may be able to navigate to the trade funds management application and view the funds that have been made available for the client's Atlanta stores, the Star Cookies product, and the next fiscal year. In an exemplary embodiment, the Key Account Manager may not be able to view the funds that have been made available for the client's Atlanta stores, the Star Chocolate product, and the next fiscal year. In addition, the Key Account Manager may not be able to view the funds that have been made available for the client's Philadelphia stores, the Star Cookies product, and the next fiscal year. In another exemplary embodiment, the Key Account Manager may not be able to view the funds that have been made available for another client's Atlanta stores, the Star Cookies product, and the next fiscal year. It should be noted that changing any criteria may remove the data from the customized database (e.g., secondary database 15) available to the Key Account Manager.

In an exemplary embodiment, the Key Account Manager may create a trade promotion. The trade promotion is pre-populated with customer data (e.g., client's Atlanta stores). The Key Account Manager may enter the time period (e.g., July 1 to July 14). In an exemplary embodiment, the Key Account Manager may select Star Cookies 32 oz 16 pack, Star Cookies 64 oz 32 pack, etc. In an exemplary embodiment, the search help and/or pull down field(s) only displays nodes (e.g., products) under the main Star Cookies node based on the working context. In this exemplary embodiment, the Star Chocolate products are not displayed because the Star Chocolate products are under the main Star Chocolate node which is different than the Star Cookies node because they are in a different branches of the hierarchy. It should be noted that customer hierarchy may work in a similar way to the product hierarchy.

In an exemplary embodiment, the Key Account Manager may spend some time (e.g., 5 hours, 1 day, 2 days, 3 days, etc.) creating the plan for the Star Cookies. In an exemplary embodiment, the Key Account Manager may navigate the calendar functionality and run an open context query. During this query, the Key Account Manager may discover that one of the promotions is missing because it was inadvertently passed over. The Key Account Manager may open up a list of templates (e.g., shell short list) that are appropriate templates based on the working context and drag a template to the calendar to create the missing promotion.

In an exemplary embodiment, the Key Account Manager may check the volumes and/or cost data. The business intelligence reports are generated and verified. It should be noted that any function disclosed herein as being performed by the any user may be automated.

In an exemplary embodiment, the Key Account Manager may search for all the trade promotions utilizing a created status which may filter out all of the trade promotions that the Key Account Manager or others users have rejected. Based on the working context, only trade promotions for the client's Atlanta stores with a Star Cookies product for the next fiscal year are received/displayed. In this exemplary embodiment, the Key Account Manager may selected a few, a plurality, or all of the trade promotions to be submitted. The trade promotions are submitted to an approval user (e.g., Sales Director) for their approval. The approval user may receive an email notifying the approval user that trade promotions are ready to be approved. In an exemplary embodiment, the approval user enters the working context (e.g., client's Atlanta stores, Star Cookie products, and next fiscal year) to obtain the trade promotions which are ready for approval. In another exemplary embodiment, the approval user links to the trade promotions via a link attached to the email notification. In another exemplary embodiment, the working context is applied to the approval user based on a dynamic element. For example, the approval user's calendar may have an entry which states that on Monday at 10 am the task of reviewing/approving Key Account Manager's trade promotions is scheduled. The system may automatically enter the appropriate working context based on this dynamic element. The approval user's calendar may have another entry which states that on Monday at 11 am the task of reviewing/approving another Key Account Manager's trade promotions is scheduled. At a specific time (before, at, or after 11 am), the system may automatically enter the appropriate working context based on this dynamic element. In an exemplary embodiment, the system may not change the working context based on the 11 am calendar entry when the approval user has not finished reviewing/approving the trade promotions scheduled to be reviewed at 10 am. In another exemplary embodiment, the system may include a rolling working context which allows the user to obtain data from a point in time to some other point in time (e.g., today plus fifteen days). For example, working context for the approval user may be for the entire morning. Therefore, the working context based on the 10 am entry and the 11 am entry would be available to the approval user. In an exemplary embodiments, the time period may be any time period (e.g., one hour, four hours, one day, three days, one week, two weeks, one month, etc.).

In another exemplary embodiment, the dynamic element may be the time the trade promotions were submitted for approval. For example, Key Account Manager1 submits trade promotions at 10 am and Key Account Manager2 submits trade promotions at 10:30 am. Because Key Account Manager1 entered their trade promotions before Key Account Manager2, the system may enter the appropriate working context for the approval user based on Key Account Manager1's submission. In another exemplary embodiment, the system may enter the appropriate working context for the approval user based on Key Account Manager2's submission being later than Key Account Manager1's submission.

In an exemplary embodiment, a Service Representative may be assigned to five stores that have ten different products (e.g., two products for each store with no overlap). On a service call, Service Representative's working context may be dynamically set to show only the two products for a particular store. In an exemplary embodiment, only the data (e.g., maintenance codes, etc.) associated with the two products may be displayed for the Service Representative. The setting of the working context works as previously disclosed.

In another exemplary embodiment, a Marketing Manager may be assigned to the entire cookie product category. The working context for the Marketing Manager may be dynamically set as was previously disclosed.

In an exemplary embodiment, a Key Account Manager may be responsible for the execution of given marketing initiatives for accounts. In addition, Key Account Manager may be responsible for developing and monitoring sales and promotion plans. In an exemplary embodiment, a Brand Manager may be responsible for the management of a specific brand to meet targets/objectives. In an exemplary embodiment, a Finance Manager may provide budgets and financial measures for the execution of trade promotions and track overall spending to avoid financial gaps and manage budget re-allocations. In an exemplary embodiment, a Trade Marketing Manager may be responsible for marketing strategies directed at customer channels, wholesalers, distributors, retailers. In an exemplary embodiment, an Area (territory) Manager may be managing and monitoring day to day sales and service operations of their assigned territories to achieve their sales, delivery and merchandising goals. In an exemplary embodiment, a Sales Director and/or Vice President of Sales may be responsible to develop and apply the sales strategy and objectives. Sales Director and/or Vice President of Sales may be responsible for monitoring of sales plans and sales pipeline and determining reasons for attainment/under achievement of responsible accounts. In an exemplary embodiment, a Marketing Director and Vice President of Marketing may be responsible for overall corporate positioning as well as trade and brand marketing initiatives. In an exemplary embodiment, a Trade Promotion Management professional may be an internal user who is working with the complete Trade Promotion Management solution. In an exemplary embodiment, a Trade Finance professional may be an internal user who is working with the financial side of the Trade Promotion Management solution. In an exemplary embodiment, a Trade Claims professional may be an internal user who is working with the claims management part of the Trade Promotion Management solution. The working context may be enabled in the non-strict mode for any of the above referenced user role.

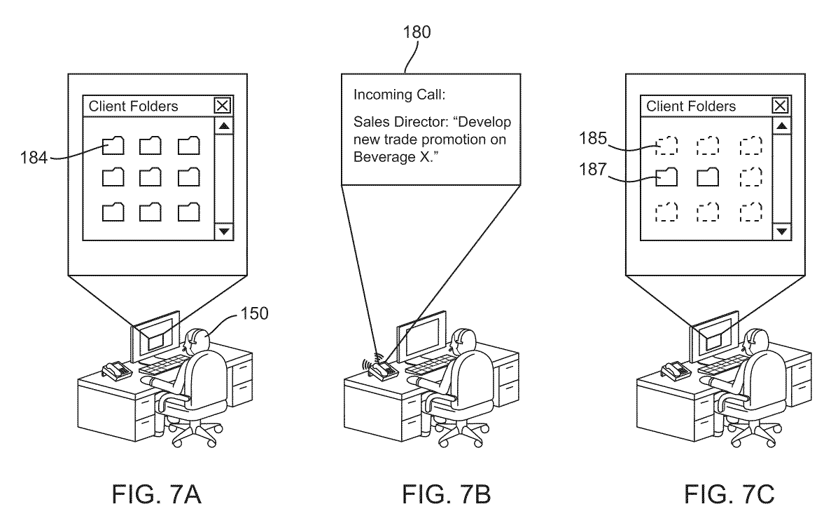

In FIGS. 7A-7C, illustrations of incoming data being utilized as a dynamic characteristic are shown, according to an exemplary embodiment. In an exemplary embodiment, salesperson 150 may have access to all beverage files 184. In exemplary embodiments, sales person 150 may have access to only product specific files, customer specific files, customer support specific files, or any combination thereof. In FIG. 7B, call salesperson 150 receives incoming data 180 which indicates that Sales Director want a new trade promotion developed for Beverage X. In exemplary embodiments, incoming data 180 may indicate the source of the data by the incoming phone number, the phone called, or any other source identification method. Based on salesperson 150 having access to all beverages file 184, salesperson 150 may be able to access Beverage X files 187 and may not be able to access Non-Beverage files 185 (see FIG. 7C). In an exemplary embodiment, based on incoming data 180, the dynamic working context may be modified to Beverage X.

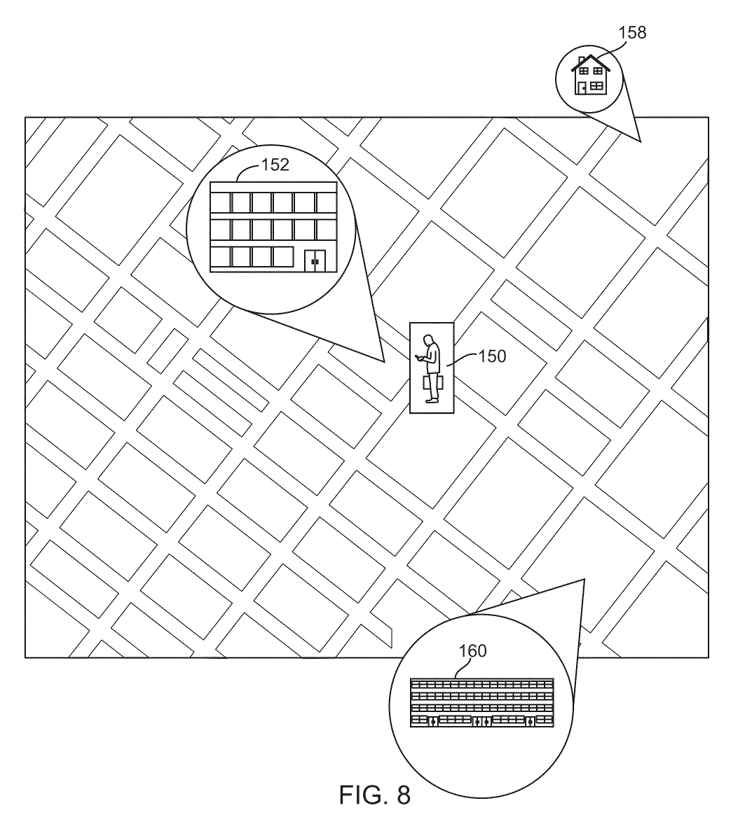

In FIG. 8, illustrations of sales locations being utilized to determine dynamic characteristics are shown, according to exemplary embodiments. In an exemplary embodiment, salesperson 150 may have three different work environments planned for today. For example, salesperson 150 may visit Client ABC at client site 152 to discuss a new trade promotion, attend a meeting with potential Client XYZ at call center 160 to evaluate call center capabilities, and work on a marketing plan for Client DEF at home 158. Based on geographic proximity (e.g., location of salesperson 150 to the location of client site 152, call center 160, and/or home 158) of salesperson 150 and targeted site, the working context is dynamically changed. In an exemplary embodiment, salesperson 150 is closer to client site 152 then to home 158 or call center 160. Therefore, the system modifies the working context to be based on Client ABC. When salesperson 150 moves closer to home 158 the system may modify the working context to be based on Client DEF. In addition, when salesperson 150 moves closer to call center 160 the system changes the working context to be based on potential Client XYZ. In another exemplary embodiment, the dynamic working context may be based on more than one factor. For example, the calendar functionality, the task functionality, location data, and/or any other dynamic data may be combined (See FIG. 3B). Client ABC may be located right next to Client DEF. Salesperson 150 may be driving by Client ABC's site to attend a meeting with Client DEF. In an exemplary embodiment, the system may prioritize dynamic characteristics. For example, calendar functionality may have first priority, task functionality may have second priority, and location data may have third priority. In this exemplary embodiment, the appointment scheduled with Client DEF takes priority over salesperson 150 being located in close proximity to Client ABC. Therefore, the working context may not change to Client ABC based on the location data. It should be noted that any priority schedule may be utilized.

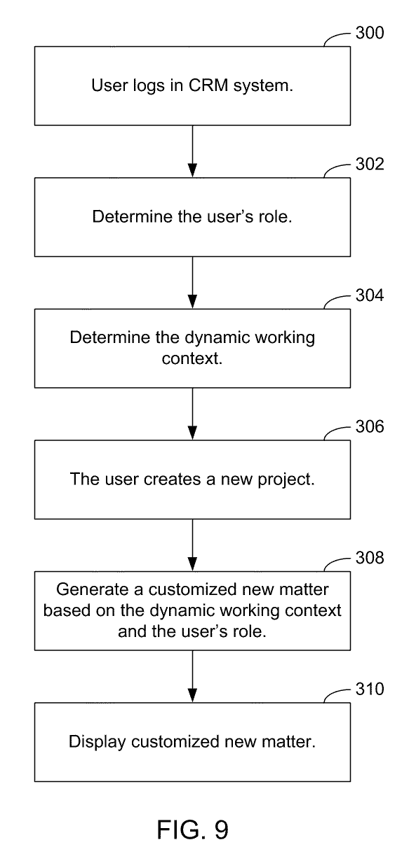

In FIG. 9, a flowchart for the working context implementation is shown, according to an exemplary embodiment. In an exemplary embodiment, the user logs into the system (step 300). The system determines the user's role (step 302). In an exemplary embodiment, the user's role(s) may determine the static working context. For example, a Key Account Manager with five customers and the tissue product line may have a static working context which is based on the five customers and the tissue product line. Therefore, the Key Account Manager may have access to secondary database 15, filter data, or a temporary database which includes data relating to the five customers and the tissue product line. In another exemplary embodiment, Sales Director may supervise ten Key Account Managers. Therefore, the Sales Director's static working context may be based on clients, product lines, personal data, company data, and/or any other data assigned to these ten Key Account Managers. In an exemplary embodiment, the dynamic working context may be determined (step 304). The dynamic working context may be based on calendar data, task data, location data, obtaining outside data (e.g., phone call source, non-manually entered data, etc.), account search data, or any other dynamically changing data. In an exemplary embodiment, the user may create a new project (e.g., a trade promotion) (step 306). The system may generate a customized new project (e.g., trade promotion) based on the dynamic working context (e.g., calendar data) and the static working context (e.g., Key Account Manager for five clients and the tissue product line) (step 308). The system may display, transfer, and/or pre-populate the data related to the project. (step 3 10).

In an exemplary embodiment, the functionality of a Client Resource Management (“CRM”) system may be utilized with this disclosure. The CRM system may be purchased from SAP Aktiengesellschaft Neurottstrasse at 16 D-69190 Walldorf Germany. In exemplary embodiments, the CRM 2007 or any other CRM systems may be utilized with this disclosure. In an exemplary embodiment, the work context attributes account hierarchy node and product category may be handled in various ways. In one exemplary embodiment, when the account hierarchy node is set as strict working context, the system may allow all subordinated account hierarchy nodes and/or all accounts assigned to these nodes. In another exemplary embodiment, when the product category is set as strict working context, the system may allow all subordinated product hierarchy nodes and/or all products assigned to these nodes.

In an exemplary embodiment, all screens (e.g., create, edit, search, etc.) may have a search help which is defaulted to the values in the working context. For example, a working context may be set to an Atlanta Client Name and a Brand XYZ Product Category. When a trade promotion is created and a product is selected the search help for the product will be defaulted with the Brand XYZ Product Category. In an exemplary embodiment, new objects and object changes may be implemented. In exemplary embodiments, the new objects and/or object changes may be related to taxation in the areas of Trade Claims Management, the Trade Funds Management, and/or the Trade Promotion Management.

In an exemplary embodiment, the working context functionality may be supported in a few, a plurality, and/or all trade areas. In exemplary embodiments, all trades areas may be trade promotion management, trade funds management, trade claims management, trades logistics management, and any function associated with distributing a product and/or service. In exemplary embodiments, working context functionality may be utilized in two different modes (e.g., strict and/or open).

In an exemplary embodiment, the strict mode may be activated. In the strict mode, the working context may not be overridden. For example, a search may not be completed for a product that is different from the one specified in the working context. In another exemplary embodiment, the product search may be completed when the working context is disabled or a working context that allows for the search of the product is enabled.

In another exemplary embodiment, the open mode may be activated. In the open mode, the working context may be disable and/or overridden. For example, a trade promotion for an account other than the one defined by the working context may be created.

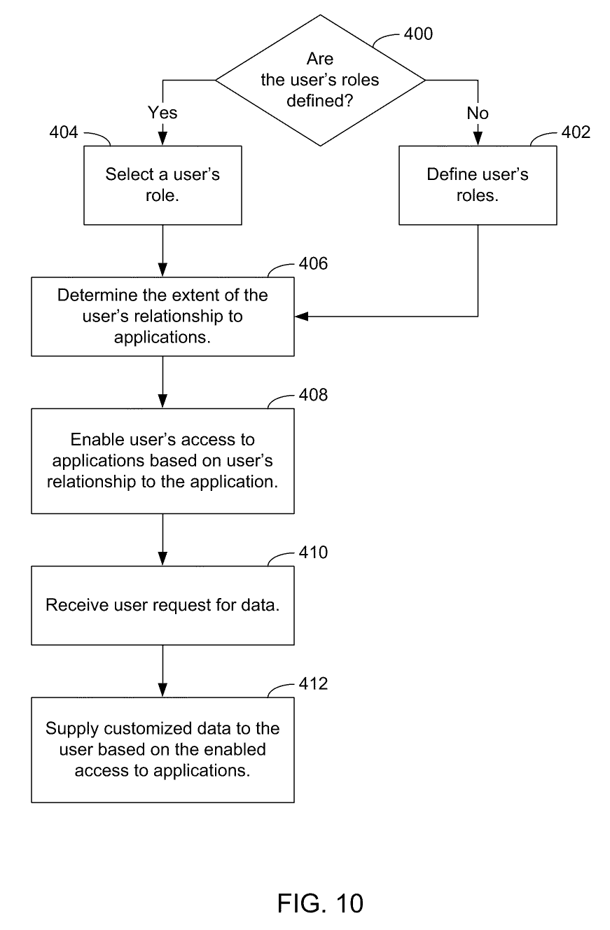

In FIG. 10, another flowchart for the working context implementation is shown, according to an exemplary embodiment. In an exemplary embodiment, the system determines whether the user's role(s) are defined (step 400). When the user's role(s) are defined the user and/or the system selects a user's role(s) (step 404). When the user's role(s) are not defined the user and/or the system defines the user's role(s) (step 402). The system may determine the extent of the user's relationship to the applications (step 406). For example, a Sales Director may have access to trade promotion data which is different than the access grant to a Key Account Manager. The system enables access to the application based on the user's relationship to the application (step 408). In an exemplary embodiment, the user request data (step 410). The system may supply customized data to the user based on the enabled access to the application (step 412).

In an exemplary embodiment, machine-readable media for managing sales using an automated process may be utilized. The machine-readable media may comprise program code stored therein executable by one or more processors to perform the automated process. The automated process may include providing by the one or more processors a working context related to a static characteristic and providing a database assigned to the working context. The automated process may also include generating a trade promotion based on the working context. The one or more processors may automatically populate the trade promotion with data based on the working context. The automated process may further include transmitting an approval request signal to an approval user. The approval request signal may include a communication link to an approval area. The approval request signal may automatically transfers an approval user to an approval area. A dynamic characteristic of the approval request signal may modify an approval user's working context. The dynamic characteristic of the approval request signal may be based on a time data (e.g., time entered by a Key Account Manager).

In an exemplary embodiment, the automated process may include providing a working context and data assigned to the working context. The automated process may include generating a trade promotion based on the working context and automatically populate the trade promotion with data based on the working context. Further, the working context may be based on a static characteristic. In addition, the working context may be based on a dynamic characteristic. The dynamic characteristic may be related to varying schedule data. The dynamic characteristic may also be related to varying spacial data. The automated process may include determining the working context based on a priority schedule for the varying schedule data and the varying spacial data.

In another exemplary embodiment, the automated process may include providing a working context related to a dynamic characteristic and providing data assigned to the dynamic characteristic. The dynamic characteristic may be related to a varying schedule data. The dynamic characteristic may also be related to varying spacial data. The dynamic characteristic may be related to non-manually entered data. The dynamic characteristic may include a first dynamic characteristic and a second dynamic characteristic and the automated process may further include prioritizing the first dynamic characteristic and the second dynamic characteristic to determine the working context based on the prioritization.

In another exemplary embodiment, the automated process may include providing a first working context related to a static characteristic and providing a first data assigned to the working context. The automated process may include providing a second working context related to a dynamic characteristic and providing a second data assigned to the dynamic characteristic. The static characteristic may be based on a user profile and the dynamic characteristic may be related to a varying schedule data. The static characteristic may be modified by a system administrator. The dynamic characteristic may include a first dynamic characteristic and a second dynamic characteristic and the automated process may further include prioritizing the first dynamic characteristic and the second dynamic characteristic to determine the working context based on the prioritization.

In another exemplary embodiment, the dynamic characteristic may be related to varying task data. The automated process may further include generating a trade claim based on the working context. The dynamic characteristic may be related to a varying time data. In addition, the dynamic characteristic may be related to varying employee relationship data. The automated process may further include generating trade funds data based on a working context. The working context may be a static working context, a dynamic working context, or a combination thereof.

Working context may not be limited to sales processes/application objects. Working context may be applied to any object in CRM or any other business software.

Static working context may mean that an attribute value may not change unless a user changes the attribute. For example, a user or a system sets the value of static working context for the product attribute to product A and product B. Later the user or the system may change the working context. However, the static value may not change unless the user or the system changes the attribute values.

Dynamic working context may mean that a system or a service (program code) changes the attribute values dynamically based on an event (e.g. new location, selection of an application object (e.g. account plan, financial posting, customer master data)). For example, the user or the system sets the working context based on customer attributes. The customer is set to Kroger 123. The user now travels to another location. The system may change the customer value of the working context to Kroger 456 based on a dynamic characteristic (e.g., location code).

In exemplary embodiments, any of the following conditions and/or any combination thereof may be utilized with a decision logic function within the working context and/or be values selected based on various data used in the system: a product attribute of a trade promotion may be defaulted into the product assignment as soon as the selected Product Planning Basis contains “Product”; a product category attribute of a trade promotion may be defaulted into the product assignment as soon as the selected Product Planning Basis contains “Product Category”; a product group attribute of a trade promotion may be defaulted into the product assignment as soon as the selected Product Planning Basis contains “Product Group”; an account attribute of a trade promotion may be written as an Account type=Account Planning Account=Account ID/Description; an account hierarchy node attribute of a trade promotion may be written as an Account type=Hierarchy Node Planning Account=Hierarchy Node ID/Description.

In exemplary embodiments, any of the following conditions and/or any combination thereof may be utilized with a decision logic function within the working context and/or be values selected based on various data used in the system: a start date attribute of a trade promotion may be checked to ensure that the Plan Start Date is within horizon; an end date attribute of a trade promotion may be checked to ensure that the Plan End Date is within horizon; a funds plan attribute of a trade promotion may be defaulted to the Trade Promotion when a new record is not created; a promotion type attribute of a trade promotion may be defaulted to the Trade Promotion when a new record is not created; a territory attribute of a trade promotion may be a default attribute in the Territory ID Field, when the territory determination is either not applied or has the WC territory in the result list.

In exemplary embodiments, any of the following conditions and/or any combination thereof may be utilized with a decision logic function within the working context and/or be values selected based on various data used in the system: a product segment attribute of a trade promotion may be defaulted into the product segment assignment which defaults the Product Planning Basis to “Product Segment”; an objective attribute of a trade promotion may be a default attribute in the Objective Field; a tactic attribute of a trade promotion may be a default attribute in the Tactic Field; a log on user attribute of a trade promotion may be a default attribute in the Employee Responsible ID Field; a product attribute of an advance search of a trade promotion may be a default Product ID in the Product ID field; a product category attribute of an advance search of a trade promotion may be a default Product Category ID in the Product Category ID field; a product group attribute of an advance search of a trade promotion may be a default Product Group ID in the Product Group ID field; an account attribute of an advance search of a trade promotion may be a default Account ID in the Account ID field; an account hierarchy node attribute of an advance search of a trade promotion may be a default Hierarchy Node ID in the Hierarchy Node ID field; a target group attribute of an advance search of a trade promotion may be a default Target Group ID in the Target Group ID field; a start date attribute of an advance search of a trade promotion may be a default Plan Start Date, such as, the first day of the period (e.g. if context is the year of 2007, start date is 1 Jan. 2007); an end date attribute of an advance search of a trade promotion may be a default Plan End Date, such as, the last day of the period (e.g. if context is the year of 2007, end date is 31 Dec. 2007); a funds plan attribute of an advance search of a trade promotion may be a default Funds Plan ID in the Funds Plan ID field; a promotion type attribute of an advance search of a trade promotion may be a default Promotion Type in the Promotion Type Field; a territory attribute of an advance search of a trade promotion may be a default attribute in the Territory ID Field; a product segment attribute of an advance search of a trade promotion may be a default attribute in the Product Segment Field; an objective attribute of an advance search of a trade promotion may be a default attribute in the Objective Field; a tactic attribute of an advance search of a trade promotion may be a default attribute in the Tactic Field; a log on user of an advance search of a trade promotion may be a default attribute in the Employee Responsible ID Field; a product attribute of templates for a trade promotion may be defaulted into the product assignment as soon as the selected Product Planning Basis contains “Product”; a product category attribute of templates for a trade promotion may be defaulted into the product assignment as soon as the selected Product Planning Basis contains “Product Category”; a product group attribute of templates for a trade promotion may be defaulted into the product assignment as soon as the selected Product Planning Basis contains “Product Group”; an account attribute of templates for a trade promotion may be Account type=Account Planning Account=Account ID/Description; an account hierarchy node attribute of templates for a trade promotion may be Account type=Hierarchy Node Planning Account=Hierarchy Node ID/Description.

When creating a template, the User Validity Date and Creation Validity Date may be within context (i.e. year); a funds plan attribute of templates for a trade promotion may be a default. When creating trade promotion from a template the Funds Plan may be a default value; a promotion type attribute of the templates for a trade promotion may be defaulted to the trade promotion when a new record is not created; a territory attribute of templates for a trade promotion may be default attribute in the Territory ID Field, if the territory determination is either not applied or has the WC territory in result list.

In exemplary embodiments, any of the following conditions and/or any combination thereof may be utilized with a decision logic function within the working context and/or be values selected based on various data used in the system: a product segment attribute of templates for a trade promotion may be defaulted into product segment assignment which may default the Product Planning Basis to “Product Segment”; an objective attribute of the templates for a trade promotion may be a default attribute in the Objective Field; a tactic attribute of templates for a trade promotion may be a default attribute in the Tactic Field; a log on user attribute of the templates for a trade promotion may be a default attribute in the Employee Responsible ID Field; a product attribute of an advance search of templates may be a default Product ID for the Product ID field; a product category attribute of an advance search of templates may be a default Product Category ID for Product Category ID field; a product group attribute for an advance search templates may be a default Product Group ID for the Product Group ID field; an account attribute for an advance search of the templates may be a default Account ID for the Account ID field; an account hierarchy node attribute for an advance search of the templates may be a default Hierarchy Node ID for the Hierarchy Node ID field; a target group attribute for an advance search of the templates may be a default Target Group ID for the Target Group ID field.

In exemplary embodiments, any of the following conditions and/or any combination thereof may be utilized with a decision logic function within the working context and/or be values selected based on various data used in the system: a start date attribute for an advance search of the templates may be a context date (i.e. year) which may be allowed for only templates that are validly created for that year; an end date attribute for an advance search of the templates may be the context date (i.e. year) which may be allowed for only templates that are validly created for that year; a funds plan attribute for an advance search of the templates may be a default for the Funds Plan; a promotion type attribute for an advance search of the templates may be a default Promotion Type in the Promotion Type Field; a territory attribute for an advance search of templates may be a default attribute in the Territory ID Field; a product segment attribute for an advance search of the templates may be a default attribute in the Product segment Field.

In exemplary embodiments, any of the following conditions and/or any combination thereof may be utilized with a decision logic function within the working context and/or be values selected based on various data used in the system: an objective attribute for an advance search of the templates may be a default attribute in the Objective Field; a tactic attribute for an advance search of the templates may be a default attribute in the Tactic Field; a log on user for an advance search of the templates may be a default attribute in the Employee Responsible ID Field; a product attribute of a marketing calendar may be defaulted into the product assignment as soon as the selected Product Planning Basis contains “Product”; a product category attribute of a marketing calendar may be defaulted into the product assignment as soon as the selected Product Planning Basis contains “Product Category”; a product group attribute of a marketing calendar may be defaulted into the product assignment as soon as the selected Product Planning Basis contains “Product Group”; an account attribute of a marketing calendar may be an Account type=Account Planning Account=Account ID/Description; an account hierarchy node attribute of a marketing calendar may be an Account type=Hierarchy Node Planning Account=Hierarchy Node ID/Description.

In exemplary embodiments, any of the following conditions and/or any combination thereof may be utilized with a decision logic function within the working context and/or be values selected based on various data used in the system: a start date attribute of a marketing calendar may be checked to ensure that the Plan Start Date is within horizon; an end date attribute of a marketing calendar may be checked to ensure that Plan End Date is within horizon; a funds plan attribute of a marketing calendar may be defaulted to the trade promotion when a new record is not created; a promotion type attribute of a marketing calendar may be defaulted to the trade promotion when a new record is not created; a territory attribute of a marketing calendar may be a default attribute in the Territory ID Field; a product segment attribute of a marketing calendar may be a default attribute in the Product segment Field; an objective attribute of a marketing calendar may be a default attribute in the Objective Field; a tactic attribute of a marketing calendar may be a default attribute in the Tactic Field; a log on user of a marketing calendar may be a default attribute in the Employee Responsible ID Field; a product attribute for an advance search of a calendar may be a default Product ID into the Product ID field; a product category attribute for an advance search of a calendar may be a default Product Category ID into the Product Category ID field; a product group attribute for an advance search of a calendar may be a default Product Group ID into Product Group ID field; an account attribute for an advance search of a calendar may be a default Account ID in the Account ID field; an account hierarchy node attribute for an advance search of a calendar may be a default Hierarchy Node ID in the Hierarchy Node ID field; a target group attribute for an advance search of a calendar may be a default Target Group ID in the Target Group ID field; a start date attribute for an advance search of a calendar may be a default Plan Start Date, such as, the first day of the period (e.g. if context is 2007, start date is 1 Jan. 2007); an end date attribute for an advance search of a calendar may be a default Plan End Date, such as, the last day of the period (e.g. if context is 2007, end date is 31 Dec. 2007); a funds plan attribute for an advance search of a calendar may be a default the Funds Plan ID in the Funds Plan ID field; a promotion type attribute for an advance search of a calendar may be a default Promotion Type in the Promotion Type Field; a territory attribute for an advance search of a calendar may be a default attribute in the Territory ID Field; a product segment attribute for an advance search of a calendar may be a default attribute in the Product Segment Field; an objective attribute for an advance search of a calendar may be a default attribute in the Objective Field; a tactic attribute for an advance search of a calendar may be a default attribute in the Tactic Field; a log on user for an advance search of a calendar may be a default attribute in the Employee Responsible ID Field; a log on user attribute of a funds plan may be a default attribute as Employee Responsible ID; a log on user attribute for an advance search of a funds plan may be a default attribute in the Employee Responsible ID Field.

In exemplary embodiments, any of the following conditions and/or any combination thereof may be utilized with a decision logic function within the working context and/or be values selected based on various data used in the system: a territory attribute of a fund may be for the Fund, it may not have the attributes Product, Category, Product Group, Account, Hierarchy Node, Territory. These attributes may be defaulted into the search criteria during the search. However, during creation, these attributes may be required depending on the fund type. For example, the user may create a new fund and select a type. The system may know which of the above attributes are required for that fund type and displays them to the user; a fund type attribute of a fund may be a default Attribute in the Fund Type Field; a log on user attribute of a fund may be a default attribute in the Employee Responsible ID Field; a territory attribute for an advance search of a fund may be a default attribute in the Territory ID Field; a fund type attribute for an advance search of a fund may be a default Attribute in the Fund Type Field; a log on user attribute for an advance search of a fund may be a default attribute in the Employee Responsible ID Field; a product attribute for an advance search of fund usages may be Product ID; a product category attribute for an advance search of fund usages may be Product Category ID; a product group attribute for an advance search of fund usages may be Product Group ID; an account attribute for an advance search of fund usages may be Account ID; an account hierarchy node attribute for an advance search of fund usages may be Account Hierarchy Node ID; a funds plan attribute for an advance search of fund usages may be Funds Plan ID; a log on user attribute for an advance search of fund usages may be a default attribute in the Created By Field.

In exemplary embodiments, any of the following conditions and/or any combination thereof may be utilized with a decision logic function within the working context and/or be values selected based on various data used in the system: a log on user attribute of a budget posting may be a default attribute such as, Employee Responsible ID; an account attribute for an advance search of budget posting may be an Account; a funds plan attribute for an advance search of budget posting may be Funds Plan ID; a log on user attribute for an advance search of budget posting may be a default attribute in the Employee Responsible ID Field; a log on user attribute of search fund postings may be a default attribute in the Created By Field; an account attribute of a create claim may be Deduction (CSR) and defaulted when there is not yet a CSD assigned, then Claiming Account and Payee may be defaulted, Payee may only be defaulted if the claiming account can be a payer Invoice Claim (CSR); Claiming Account and Payee may be defaulted. In addition, Payee may be defaulted if the claiming account can be a payer.

In exemplary embodiments, any of the following conditions and/or any combination thereof may be utilized with a decision logic function within the working context and/or be values selected based on various data used in the system: a funds plan attribute of a create claim may be a Funds Plan; a territory attribute of a create claim may be a default attribute in the Territory ID Field, when the territory determination is either not applied or has the WC territory in result list; a product category attribute for an advance search of claim may depend on availability of product search, if the search of claims is enabled with item search for products, then this may be defaulted; a product group attribute for an advance search of claim may depend on the availability of product search, if the search of claims is enabled with item search for the products, then this may be defaulted; an account attribute for an advance search of claim may be Claiming Account ID; an account attribute of prepayments may be Planning Account (payee derived from Planning Account via partner determination); a funds plan attribute of prepayments may be funds plan; a territory attribute of prepayments may be a default attribute in the Territory ID Field, when the territory determination is either not applied or has the WC territory in result list; a log on user attribute of prepayments may be a default attribute in the Employee Responsible ID Field; an account attribute for an advance search of prepayments may be Planning Account; a funds plan attribute for an advance search of prepayments may be Fund Plan ID; a territory attribute for an advance search of prepayments may be a default attribute in the Territory ID Field; a log on user attribute for an advance search of prepayments may be a default attribute in the Employee Responsible ID Field; an account attribute for an advance search of claim submissions may be Claiming Account ID; a territory attribute for an advance search of claim submissions may be a default attribute in the Territory ID Field; a log on user attribute for an advance search of claim submissions may be a default attribute in the Employee Responsible ID Field.

In exemplary embodiments, any of the following conditions and/or any combination thereof may be utilized with a decision logic function within the working context and/or be values selected based on various data used in the system: a product category attribute for an advance search of settlements may depend on availability of the product search, if the search of claims is enabled with item search for products, then this may be defaulted; a product group attribute for an advance search of settlements may depend on availability of the product search, if the search of claims is enabled with item search for the products, then this may be defaulted; an account attribute for an advance search of settlements may be Claiming Account ID; a log on user attribute for an advance search of settlements may be a default attribute in the Created By Field; a product attribute of a deal may be a defaulted into the product assignment as soon as the selected Product Planning Basis contains “Product”; a product category attribute of a deal may be defaulted into the product assignment as soon as the selected Product Planning Basis contains “Product Category”; a product group attribute of a deal may be defaulted into the product assignment as soon as the selected Product Planning Basis contains “Product Group”; an account attribute of a deal may be an Account type=Account Planning Account=Account ID/Description; an account hierarchy node attribute of a deal may be an Account type=Hierarchy Node Planning Account=Hierarchy Node ID/Description; a start date attribute of a deal may be checked to ensure that the Plan Start Date is within horizon; an end date attribute of a deal may be checked to ensure that Plan End Date is within horizon; a funds plan attribute of a deal may be defaulted to the trade promotion when a new record is not created; a promotion type attribute of a deal may be defaulted to the trade promotion when a new record is not created; a territory attribute of a deal may be a default attribute in the Territory ID Field, when the territory determination is either not applied or has the WC territory in result list.

In exemplary embodiments, any of the following conditions and/or any combination thereof may be utilized with a decision logic function within the working context and/or be values selected based on various data used in the system: an objective attribute of a deal may be a default attribute in the Objective Field; a tactic attribute of a deal may be a default attribute in the Tactic Field; a log on user attribute of a deal may be a default attribute in the Employee Responsible ID Field; a product attribute for an advance search of a deal may be a default Product ID into Product ID field; a product category attribute for an advance search of a deal may be a default Product Category ID into Product Category ID field; a product group attribute for an advance search of a deal may be a default Product Group ID into Product Group ID field; an account attribute for an advance search of a deal may be a default Account ID in the Account ID field; an account hierarchy node attribute for an advance search of a deal may be a default Hierarchy Node ID in the Hierarchy Node ID field; a target group attribute for an advance search of a deal may be a default Target Group ID in the Target Group ID field; a funds plan attribute for an advance search of a deal may be a default the Funds Plan ID in the Funds Plan ID field; a promotion type attribute for an advance search of a deal may be a default Promotion Type in the Promotion Type Field; a territory attribute for an advance search of a deal may be a default attribute in the Territory ID Field; an objective attribute for an advance search of a deal may be a default attribute in the Objective Field; a tactic attribute for an advance search of a deal may be a default attribute in the Tactic Field; a log on user attribute for an advance search of a deal may be a default attribute in the Employee Responsible ID Field; a product attribute of agreements may be defaulted into the product assignment as soon as the selected Product Planning Basis contains “Product”; a product category attribute of agreements may be defaulted into the product assignment as soon as the selected Product Planning Basis contains “Product Category”; a product group attribute of agreements may be defaulted into the product assignment as soon as the selected Product Planning Basis contains “Product Group”; an account attribute of agreements may be an Account type=Account Planning Account=Account ID/Description; an account hierarchy node attribute of agreements may be an Account type=Hierarchy Node Planning Account=Hierarchy Node ID/Description; a territory attribute of agreements may be a default attribute in the Territory ID Field, then the territory determination is either not applied or has the WC territory in result list.

In exemplary embodiments, any of the following conditions and/or any combination thereof may be utilized with a decision logic function within the working context and/or be values selected based on various data used in the system: a log on user attribute of agreements may be a default attribute in the Employee Responsible ID Field; a product attribute for an advance search of agreements may be a default Product ID into Product ID field; a product category attribute for an advance search of agreements may be a default Product Category ID into Product Category ID field; a product group attribute for an advance search of agreements may be a default Product Group ID into the Product Group ID field; an account attribute for an advance search of agreements may be a default Account ID in the Account ID field; an account hierarchy node attribute for an advance search of agreements may be a default Hierarchy Node ID in the Hierarchy Node ID field; a target group attribute for an advance search of agreements may be a default Target Group ID in the Target Group ID field; a start date attribute for an advance search of agreements may be a default Plan Start Date, such as, the first day of the period (e.g. if context is 2007, start date is 1 Jan. 2007); an end date attribute for an advance search of agreements may be a default Plan End Date, such as, the last day of the period (e.g. if context is 2007, end date is 31 Dec. 2007); a territory attribute for an advance search of agreements may be a default attribute in the Territory ID Field; a log on user attribute for an advance search of agreements may be a default attribute in the Employee Responsible ID Field.

In exemplary embodiments, any of the following conditions and/or any combination thereof may be utilized with a decision logic function within the working context and/or be values selected based on various data used in the system: a start date attribute of a search chargebacks may be a low posting date; an end date attribute of a search chargebacks may be a high posting date; a territory attribute of a search chargebacks may be a default attribute in the Territory ID Field; a log on user attribute of a search chargebacks may be a default attribute in the Employee Responsible ID Field; an account attribute for an advance search of account hierarchy may be a default Corresponding Search Criteria; an account hierarchy node attribute for an advance search of account hierarchy may be a default Corresponding Search Criteria; an account attribute for an advance search of account may be a default Corresponding Search Criteria; a product category attribute of a product may be a default Base Category ID; a product attribute for an advance search of products may be a default Corresponding Search Criteria; a product category attribute for an advance search of products may be a default Corresponding Search Criteria; a start date attribute of a search pricing and promotion guidelines may be a default date which is later than the Plan Start Date; an end date attribute of a search pricing and promotion guidelines may be a default date earlier than the Plan End Date; a territory attribute of a search pricing and promotion guidelines may be a default attribute in the Territory ID Field; a log on user attribute of a search pricing and promotion guidelines may be a default attribute in the Changed By Field; a product attribute of a create pricing and promotion guidelines may be a default Corresponding Criteria; a product category attribute of a create pricing and promotion guidelines may be a default Corresponding Criteria; a product group attribute of a create pricing and promotion guidelines may be a default Corresponding Criteria; a target group attribute of a create pricing and promotion guidelines may be a default Corresponding Criteria; a start date attribute of a create pricing and promotion guidelines may be a default Plan Start Date; an end date attribute of a create pricing and promotion guidelines may be a default Plan End date; a territory attribute of a create pricing and promotion guidelines may be a default attribute in the Territory ID Field; a product segment attribute of a create pricing and promotion guidelines may be defaulted into the product segment assignment.

In exemplary embodiments, any of the following conditions and/or any combination thereof may be utilized with a decision logic function within the working context and/or be values selected based on various data used in the system: a product attribute of a search pricing and promotion violations may be a default Corresponding Search Criteria; a product category attribute of a search pricing and promotion violations may be a default Corresponding Search Criteria; a product group attribute of a search pricing and promotion violations may be a default Corresponding Search Criteria; an account attribute of a search pricing and promotion violations may be a default Corresponding Search Criteria; an account hierarchy node attribute of a search pricing and promotion violations may be a default Corresponding Search Criteria; a target group attribute of a search pricing and promotion violations may be a default Corresponding Search Criteria; a start date attribute of a search pricing and promotion violations may be a default later than the Plan Start Date; an end date attribute of a search pricing and promotion violations may be a default Earlier than the Plan End Date; a promotion type attribute of a search pricing and promotion violations may be a default Corresponding Search Criteria; a territory attribute of a search pricing and promotion violations may be a default attribute in the Territory ID Field; a product segment attribute of a search pricing and promotion violations may be a default attribute in the Product segment Field; an objective attribute of a search pricing and promotion violations may be a default attribute in the Objective Field; a tactic attribute of a search pricing and promotion violations may be a default attribute in the Tactic Field; a log on user attribute of a search pricing and promotion violations may be a default attribute in the Employee Responsible ID Field; a product attribute of a search pricing and promotion parameters may be a default Corresponding Search Criteria; a product category attribute of a search pricing and promotion parameters may be a default Corresponding Search Criteria; a product group attribute of a search pricing and promotion parameters may be a default Corresponding Search Criteria; a start date attribute of a search pricing and promotion parameters may be a default date later than the Plan Start Date; an end date attribute of a search pricing and promotion parameters may be a default date earlier than the Plan End Date; a territory attribute of a search pricing and promotion parameters may be a default attribute in the Territory ID Field; a product segment attribute of a search pricing and promotion parameters may be a default attribute in the Product segment Field; a log on user attribute of a search pricing and promotion parameters may be a default attribute in the Changed By Field; a product segment attribute of a mass change and copy from trade promotion search may be utilized when the product attribute is selected, the attribute is defaulted and/or defaults as Product Planning Basis; a log on user attribute of a mass change and copy from trade promotion search may be utilized when the Employee Responsible attribute is selected and/or is the default attribute in the Employee Responsible ID Field; a product attribute of a mass approval may be a default Corresponding Search Criteria; a product category attribute of a mass approval may be a default Corresponding Search Criteria; a product group attribute of a mass approval may be a default Corresponding Search Criteria; an account attribute of a mass approval may be a default Corresponding Search Criteria; an account hierarchy node attribute of a mass approval may be a default Corresponding Search Criteria; a target group attribute of a mass approval may be a default Corresponding Search Criteria; a promotion type attribute of a mass approval may be a default Corresponding Search Criteria; a product category attribute for an indirect relationships search may be a default Product Category ID into Product Category ID field; a product group attribute for an indirect relationships search may be a default Product Group ID in the Product Group ID field; an account attribute for an indirect relationships search may be a default Account ID in the Indirect Account ID field; an account hierarchy node attribute for an indirect relationships search may be a default Hierarchy Node ID in the Indirect Hierarchy Node ID field; a target group attribute for an indirect relationships search may be a default Target Group in the Indirect Target Group field; a product category attribute of indirect relationships may be a default Product Category ID in the Product Category ID field; a product group attribute of indirect relationships may be a default Product Group ID in the Product Group ID field; an account attribute of indirect relationships may be an Account type=Account Planning Account=Account ID/Description; an account hierarchy node attribute of indirect relationships may be an Account type=Hierarchy Node Planning Account=Hierarchy Node ID/Description; a target group attribute of indirect relationships may be an Account type=Target Group Planning Account=Target Group /Description; a product category attribute of wholesaler spits may be a default Product Category ID into Product Category ID field; a product group attribute of wholesaler spits may be a default Product Group ID in the Product Group ID field; an account attribute of wholesaler spits may be a default Account ID in the Indirect Account ID field; an account hierarchy node attribute of wholesaler spits may be a default Hierarchy Node ID in the Indirect Hierarchy Node ID field; a target group attribute of wholesaler spits may be a default Target Group in the Indirect Target Group field; a start date attribute of a wholesaler may be a default date later than then the Valid From Date; an end date attribute of a wholesaler may be a default date earlier than the Valid to Date.

In exemplary embodiments, any of the following conditions and/or any combination thereof may be utilized with a decision logic function within the working context and/or be values selected based on various data used in the system: a product attribute of overlap checks may be a default Corresponding Search Criteria; a product category attribute of overlap checks may be a default Corresponding Search Criteria; a product group attribute of overlap checks may be a default Corresponding Search Criteria; an account attribute of overlap checks may be a default Corresponding Search Criteria; an account hierarchy node attribute of overlap checks may be a default Corresponding Search Criteria; a target group attribute of overlap checks may be a default Corresponding Search Criteria; a start date attribute of overlap checks may be a default Plan Start Date; an end date attribute of overlap checks may be a default Plan End Date; a funds plan attribute of overlap checks may be a default Funds Plan; a promotion type attribute of overlap checks may be a default Corresponding Search Criteria; a product attribute for an editable list view may be a default Corresponding Search Criteria; a product category attribute for an editable list view may be a default Corresponding Search Criteria; a product group attribute for an editable list view may be a default Corresponding Search Criteria; an account attribute for an editable list view may be a default Corresponding Search Criteria; an account hierarchy node attribute for an editable list view may be a default Corresponding Search Criteria; a target group attribute for an editable list view may be a default Corresponding Search Criteria; a start date attribute for an editable list view may be a default date later than the Plan Start Date; an end date attribute for an editable list view may be a default date earlier than the Plan End Date; a funds plan attribute for an editable list view may be a default Funds Plan; a promotion type attribute for an editable list view may be a default Corresponding Search Criteria; a territory attribute for an editable list view may be a default attribute in the Territory ID Field; a product segment attribute for an editable list view may be a default attribute in the Product segment Field; an objective attribute for an editable list view may be a default attribute in the Objective Field; a tactic attribute for an editable list view may be a default attribute in the Tactic Field; a log on user attribute for an editable list view may be a default attribute in the Employee Responsible ID Field; a log on user attribute of a job monitor may be a default attribute in the Created By Field; a log on user attribute of a segment builder may be a default attribute in the Changed By Field; a log on user attribute of a settlement due list items may be a default attribute in the Transaction Created By Field.

The disclosure is described above with reference to drawings. These drawings illustrate certain details of specific embodiments that implement the systems and methods and programs of the present disclosure. However, describing the disclosure with drawings should not be construed as imposing on the disclosure any limitations that may be present in the drawings. The present disclosure contemplates methods, systems and program products on any machine-readable media for accomplishing its operations. The embodiments of the present disclosure may be implemented using an existing computer processor, or by a special purpose computer processor incorporated for this or another purpose or by a hardwired system. No claim element herein is to be construed under the provisions of 35 U.S.C. §112, sixth paragraph, unless the element is expressly recited using the phrase “means for.” Furthermore, no element, component or method step in the present disclosure is intended to be dedicated to the public, regardless of whether the element, component or method step is explicitly recited in the claims.

As noted above, embodiments within the scope of the present disclosure include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the disclosure are described in the general context of method steps which may be implemented in one embodiment by a program product including machine-executable instructions, such as program code, for example, in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present disclosure may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, servers, minicomputers, mainframe computers, and the like. Embodiments of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the disclosure might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules, and other data for the computer.

It should be noted that although the flowcharts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the disclosure have been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

What is claimed is:

1. Machine-readable media for managing sales using an automated process, the machine-readable media comprising program code stored therein executable by one or more processors to perform the automated process, the automated process comprising:
providing by the one or more processors a working context;
providing data assigned to the working context; and
generating a trade promotion based on the working context;
wherein the one or more processors being configured to automatically populate the trade promotion with data based on the working context.

2. The machine-readable media of claim 1, wherein the working context is based on a static characteristic.

3. The machine-readable media of claim 1, wherein the working context is based on a dynamic characteristic.

4. The machine-readable media of claim 3, wherein the dynamic characteristic is related to varying schedule data.

5. The machine-readable media of claim 3, wherein the dynamic characteristic is related to varying task data.

6. The machine-readable media of claim 1, further comprising generating a trade claim based on the working context.

7. Machine-readable media for managing sales using an automated process, the machine-readable media comprising program code stored therein executable by one or more processors to perform the automated process, the automated process comprising:
providing a working context related to a dynamic characteristic; and
providing data assigned to the dynamic characteristic.

8. The machine-readable media of claim 7, wherein the dynamic characteristic being related to a varying time data.

9. The machine-readable media of claim 7, wherein the dynamic characteristic being related to varying employee relationship data.

10. The machine-readable media of claim 7, wherein the dynamic characteristic being related to non-manually entered data.

11. The machine-readable media of claim 7, further comprising generating a trade funds data based on the working context.

12. Machine-readable media for managing sales using an automated process, the machine-readable media comprising program code stored therein executable by one or more processors to perform the automated process, the automated process comprising:
providing a first working context related to a static characteristic;
providing a first data assigned to the first working context;
providing a second working context related to a dynamic characteristic; and
providing a second data assigned to the second working context.

13. The machine-readable media of claim 12, wherein the static characteristic being based on a user profile and the dynamic characteristic being related to a varying schedule data.

14. The machine-readable media of claim 12, further comprising generating trade funds data based on the first working context and the second working context.

15. The machine-readable media of claim 12, further comprising generating a trade funds data based on the first working context and a trade claim based on the second working context.
